(19) United States
(12) Patent Application Publication
(10) Pub. No.: US 2019/0037612 A1
(43) Pub. Date: Jan. 31, 2019

(54) CONNECTING METHOD TO AN INFORMATION CAPTURE DEVICE

(71) Applicant: GETAC TECHNOLOGY CORPORATION, Hsinchu County (TW)

(72) Inventor: Shi-Tsan Lin, Taipei City (TW)

(21) Appl. No.: 15/663,591

(22) Filed: Jul. 28, 2017

(51) Int. Cl. H04W 76/02; H04W 12/06

(52) U.S. Cl. CPC H04W 76/02; H04W 76/06; H04W 12/06

(57) ABSTRACT

A connecting method to an information capture device includes establishing a wireless communication to a server with a first wireless transmission module, executing a certification procedure with the server via the first wireless transmission module after the wireless communication is established, receiving an identification data from the server after the certification procedure is passed, receiving connection information of at least one portable information capture device via a second wireless transmission module according to the identification data, and establishing a wireless communication to a selected information capture device of the at least one portable information capture device with the second wireless transmission module according to the connection information of the selected information capture device, so that data is transmitted between the selected information capture device and the second wireless transmission module.

### BACKGROUND OF THE INVENTION

### Field of the Invention

The present invention relates to control technology of information capture devices and, more particularly, to a connecting method to an information capture device.

### Description of the Prior Art

In general, portable information capture devices capture medium data pertaining to images, sounds, and the like. With security awareness among the general public on the rise, the portable information capture devices are versatile when functioning as security aid devices, because of their portability and capability to effectuate instant information capture. For instance, police officers on duty are equipped with the portable information capture devices to assist them in policing, not to mention that medium data recorded on the portable information capture devices serves an evidential purpose.

However, it is inconvenient for users to manage the medium data recorded on the information capture devices. For example, data stored in the memory of the information capture devices has to be manually sent by the users to a computer and then saved thereon before being managed by the computer.

### SUMMARY OF THE INVENTION

In an embodiment, a connecting method to an information capture device, comprising the steps of: establishing a wireless communication to a server with a first wireless transmission module; executing a certification procedure with the server via the first wireless transmission module after the wireless communication is established; receiving an identification data from the server after the certification procedure is passed; receiving connection information of at least one portable information capture device via a second wireless transmission module according to the identification data; and establishing a wireless communication to a selected information capture device of the at least one portable information capture device with the second wireless transmission module according to the connection information of the selected information capture device, thereby transmitting data between the selected information capture device and the second wireless transmission module.

In conclusion, a connecting method to an information capture device according to an embodiment of the present invention is applicable to a mobile device so that the mobile device establishes a wireless communication to an information capture device anytime for the sake of data transmission, rendering feasible to confirm, save, and/or edit data captured by the information capture device anytime.

### BRIEF DESCRIPTION OF THE DRAWINGS

FIG. 1 is a schematic view of a surroundings surveillance system according to an embodiment of the present invention;

FIG. 2 is a block diagram of a mobile device of FIG. 1 according to an embodiment of the present invention;

FIG. 3 is a schematic view of the process flow of a connecting method to an information capture device according to an embodiment of the present invention;

FIG. 4 is a schematic view of a display frame of the mobile device of FIG. 1 according to the first embodiment of the present invention;

FIG. 5 is a schematic view of the display frame of the mobile device of FIG. 1 according to the second embodiment of the present invention;

FIG. 6 is a schematic view of the display frame of the mobile device of FIG. 1 according to the third embodiment of the present invention;

FIG. 7 is a schematic view of the display frame of the mobile device of FIG. 1 according to the fourth embodiment of the present invention;

FIG. 8 is a schematic view of the display frame of the mobile device of FIG. 1 according to the fifth embodiment of the present invention;

FIG. 9 is a schematic view of the display frame of the mobile device of FIG. 1 according to the sixth embodiment of the present invention;

FIG. 10 is a schematic view of the process flow of the connecting method to an information capture device according to another embodiment of the present invention;

FIG. 11 is a block diagram of the mobile device of FIG. 1 according to another embodiment of the present invention; and

FIG. 12 is a block diagram of the mobile device of FIG. 1 according to yet another embodiment of the present invention.

### DETAILED DESCRIPTION OF THE EMBODIMENTS

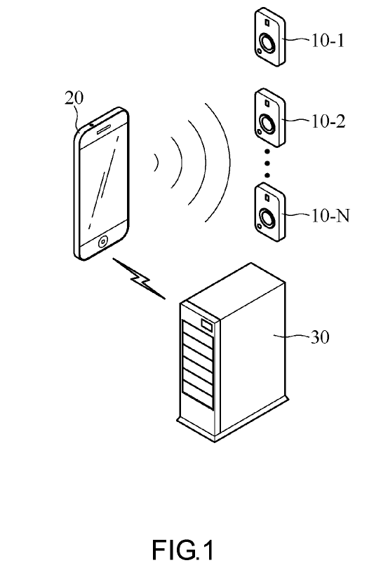

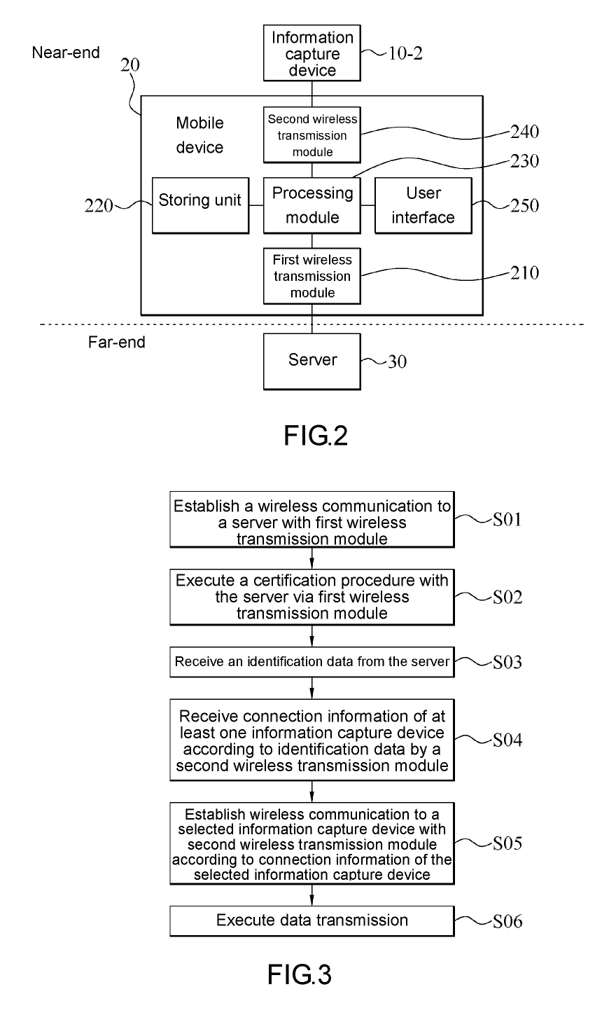

FIG. 1 is a schematic view of a surroundings surveillance system according to an embodiment of the present invention. FIG. 2 is a block diagram of a mobile device of FIG. 1 according to an embodiment of the present invention. Referring to FIG. 1 and FIG. 2, the surroundings surveillance system comprises at least one information capture device 10-1-10-N, a mobile device 20 and a server 30. Relative to the at least one information capture device 10-1-10-N, the mobile device 20 is a near-end device, whereas the server 30 is a far-end device. Therefore, the at least one information capture device 10-1-10-N lies within a signal range of short-distance wireless signals of the mobile device 20. In some embodiments, the at least one information capture device 10-1-10-N is a multimedia capture device, such as a body-worn camera, Walkman, pen recorder or dashboard camera. The mobile device 20 is a portable electronic device capable of wireless connection, such as a cellular phone or tablet. The server 30 comprises one or more hosts, and the hosts are each a computer or server, but the present invention is not limited thereto.

The mobile device 20 comprises a first wireless transmission module 210, a storing unit 220, a processing module 230, a second wireless transmission module 240 and a user interface 250. The processing module 230 is coupled to the first wireless transmission module 210, the storing unit 220, the second wireless transmission module 240 and the user interface 250.

FIG. 3 is a schematic view of the process flow of a connecting method to an information capture device according to an embodiment of the present invention. In some embodiments, the processing module 230 executes a firmware or software algorithm stored in the storing unit 220 and thereby effectuates the connecting method to an information capture device according to an embodiment of the present invention. The firmware or software algorithm is implemented by a plurality of computer program commands. In some embodiments, the computer program commands are stored in a computer program product. The computer program product is a readable record medium which can be loaded to the mobile device 20 and executed. In some embodiments, the computer program commands are each a computer program product and transmitted wiredly or wirelessly to the mobile device 20 (so as to be stored in the storing unit 220.)

Referring to FIG. 1 through FIG. 3, to manage the data in one of the at least one information capture device 10-1-10-N, the processing module 230 enables the first wireless transmission module 210 to establish a wireless communication to the server 30 (step S01).

After establishing a wireless communication to the server 30, the processing module 230 executes a certification procedure with the server 30 via the first wireless transmission module 210 (step S02).

After the certification procedure is passed, the processing module 230 receives an identification data (hereinafter referred to as first identification data) from the server 30 via the first wireless transmission module 210 (step S03). If the certification procedure is not passed, the processing module 230 sends a certification failure message to the user interface 250 according to a certification failure notice fed back from the server 30, with a view to notifying a user of the failure of the certification procedure to be passed.

Afterward, the processing module 230 uses the second wireless transmission module 240 to receive connection information of the at least one information capture device 10-1-10-N according to the first identification data (step S04). In some embodiments, the at least one information capture device 10-1-10-N broadcasts wireless signals carrying its connection information and identification data (hereinafter referred to as second identification data). The second wireless transmission module 240 scans for the wireless signals within a signal range and confirms the second identification data in each wireless signal by the first identification data. The second wireless transmission module 240 receives wireless signals carrying the second identification data which matches the first identification data to obtain the connection information carried by the wireless signals. For instance, the second wireless transmission module 240 receives the wireless signals carrying the second identification data which has the same contents as the first identification data.

When one of the at least one information capture device 10-1-10-N (hereinafter referred to as selected information capture device (say 10-2)) is selected, the processing module 230 establishes a wireless communication to the selected information capture device 10-2 with the second wireless transmission module 240 according to the connection information of the selected information capture device 10-2 (step S05). In some embodiments, the mobile device 20 establishes a wireless communication by performing an identification procedure with the information capture device 10-2, using a confidential certification mechanism (for example, RSA certification mechanism). For instance, the processing module 230 sends a request signal to the information capture device 10-2 through the second wireless transmission module 240. After receiving the request signal, a processing module (not shown) of the information capture device 10-2 generates an encrypted string according to a pre-stored public key and sends the encrypted string to the mobile device 20. Afterward, the processing module 230 (or the second wireless transmission module 240) decrypts the encrypted string according to a private key contained in authority data D1 and sends the decrypted string to the information capture device 10-2 through the second wireless transmission module 240, allowing the information capture device 10-2 to confirm (according to the string sent from the mobile device 20) whether the mobile device 20 is controllable. Therefore, if the information capture device 10-2 confirms that the string currently sent matches the string previously sent to the mobile device 20, the information capture device 10-2 determines that the mobile device 20 is controllable and thus finishes its wireless communication with the mobile device 20.

After establishing a wireless communication to the selected information capture device 10-2, the mobile device 20 executes data transmission with the selected information capture device 10-2 via the second wireless transmission module 240 (step S06). For instance, the selected information capture device 10-2 sends its captured and/or stored medium data to the mobile device 20. Alternatively, the mobile device 20 sends control commands to the selected information capture device 10-2 to enable the selected information capture device 10-2 to take a related action (for example, start recording or get connected to another device.) Alternatively, the mobile device 20 receives state information of the information capture device 10-2 by an application. Therefore, the mobile device 20 displays by push technology the received state information on a user interface (for example, a screen) or in a related field of the application. Therefore, the user logs in to the application or executes a specific page of the application from the notice bar of a cellular phone so as to be notified of the state information of the information capture device 10-2. The state information is, for example, about the current power level of a body-worn camera connected to a cellular phone, the network connection, whether the body-worn camera is shooting a video, and whether the flash of the body-worn camera is on.

In some embodiments, after the processing module 230 receives the connection information of the at least one information capture device 10-1-10-N, the user interface 250 displays device options indicative of the information capture devices 10-1-10-N, respectively, so that the user can select one of the at least one information capture device to connect with. In some embodiments, the user interface 250 is a touchscreen, a combination of a conventional display screen and physical keys, or a combination of a touchscreen and one or more physical keys.

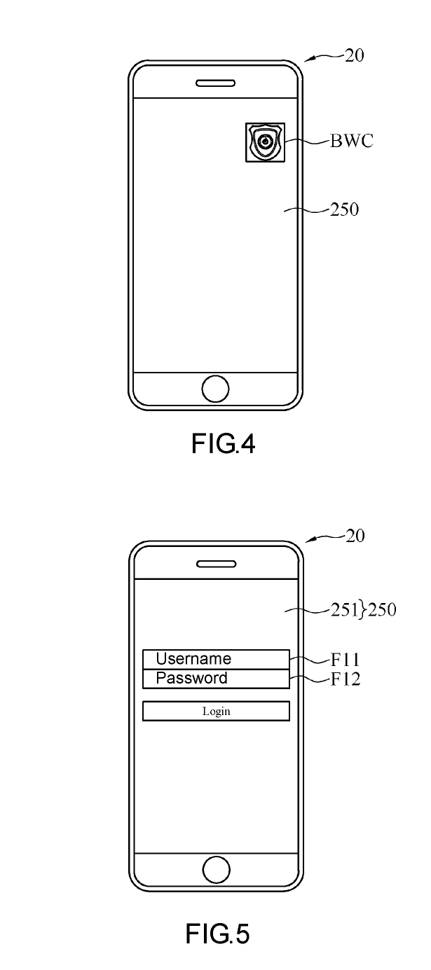

For instance, for illustrative sake, the description below is exemplified by a touchscreen functioning as the user interface 250. If the connecting method to an information capture device is effectuated by an application, the processing module 230 downloads the application from an application server via the first wireless transmission module 210 or the second wireless transmission module 240 to the storing unit 220 and displays an interface icon BWC on the touchscreen (i.e., the user interface 250), as shown in FIG. 4. The application is a mobile application (mobile app or app for short).

When the user selects the interface icon BWC, the user interface 250 generates an input signal corresponding to the interface icon BWC. The processing module 230 receives the input signal corresponding to the interface icon BWC. The processing module 230 executes the application in response to the input signal corresponding to the interface icon BWC.

In an embodiment, the processing module 230 executes the application for the first time to enable the first wireless transmission module 210 to establish a wireless communication to the server 30 and display a login frame 251 on the touchscreen, as shown in FIG. 5. The login frame 251 has a username entry field F11 and a password entry field F12 for receiving a username and a password, respectively. When the processing module 230 receives the username and the password by the login frame 251, the processing module 230 sends the username and the password to the server 30 via the first wireless transmission module 210, so as to execute a login certification procedure.

In some embodiments, the server 30 stores one or more valid usernames, valid passwords for the valid usernames, and the first identification data associated with the valid usernames. The identification data either denotes the at least one information capture device 10-1-10-N directly or denotes a group which the at least one information capture device 10-1-10-N belongs to.

The server 30 compares the valid usernames with the valid passwords for the valid usernames according to the usernames and the passwords from the mobile device 20. If one of the usernames matches one of the stored valid usernames (hereinafter referred to as “specific valid username”) and the corresponding one of the passwords also matches the valid password for the specific valid username (i.e., passing the certification procedure), the server 30 sends the first identification data corresponding to the specific valid username to the mobile device 20.

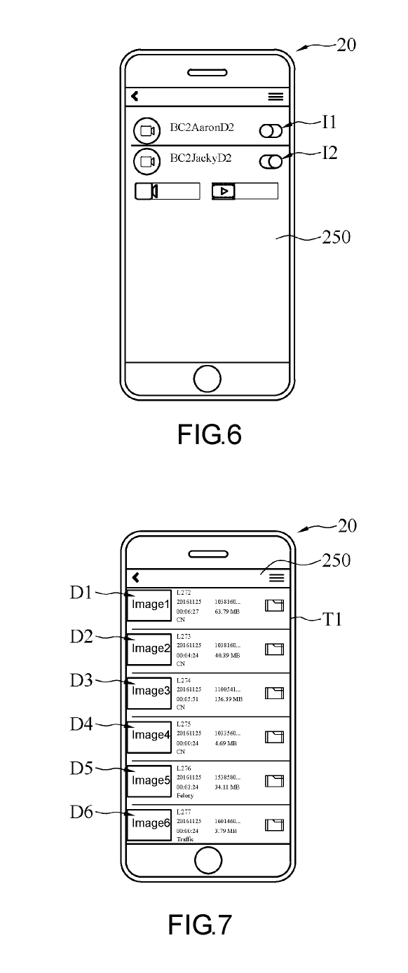

After the mobile device 20 receives the first identification data, the second wireless transmission module 240 searches the wireless signal range for the at least one information capture device 10-1-10-N by the first identification data to locate the valid information capture devices 10-1, 10-2 within the wireless signal range (for example, the information capture devices which have the second identification data identical to the first identification data) and fetch the connection information of the information capture devices 10-1, 10-2 thus located. After the information capture devices 10-1, 10-2 are located, the processing module 230 displays on the user interface 250 device options 11,12 indicative of the information capture devices 10-1, 10-2 located, as shown in FIG. 6. When the user enables the device option 12 through the user interface 250 to select the information capture device 10-2, the processing module 230 establishes a wireless communication to the selected information capture device 10-2 with the second wireless transmission module 240 according to the connection information of the selected information capture device 10-2.

In some embodiments, after the wireless communication to the selected information capture device 10-2 is established, the processing module 230 receives at least one audiovisual data from the selected information capture device 10-2 via the second wireless transmission module 240.

In some embodiments, the processing module 230 displays on the user interface 250 an audiovisual table T1 for received audiovisual data D1-D6 according to the audiovisual data D1-D6, as shown in FIG. 7.

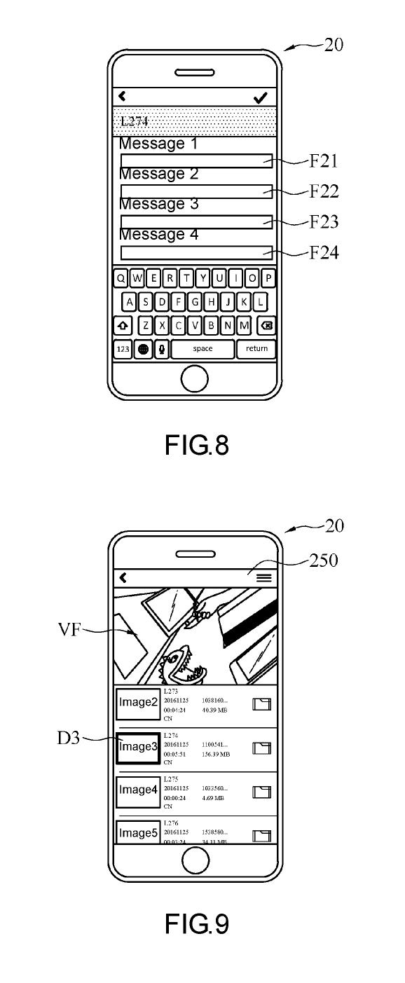

In some embodiments, the processing module 230 receives, according to the audiovisual table T1, an audiovisual selection signal indicative of selecting a selected audiovisual data (D3, for example) from the audiovisual data D1-D6 and provides, according to the audiovisual selection signal, edit fields F21-F24 for at least one audiovisual information item of the selected audiovisual data D3, as shown in FIG. 8. Therefore, the processing module 230 displays an edit frame (which has the edit fields F21-F24) for the selected audiovisual data D3 on the user interface 250 to allow the user to compile a message related to the selected audiovisual data D3. In some embodiments, the user makes confirmation-oriented multiple clicks or selects a specific option in a right-click menu to enable the mobile device 20 to be informed of the selected audiovisual data D3 selected by the user and switch the user interface 250 in such a manner that the edit frame for the selected audiovisual data D3 is displayed. In some embodiments, messages related to an event count, event name, event type, contact's full name, contact's date of birth, and authorization number are entered into the edit fields F21-F24, respectively. In some embodiments, the edit fields F21-F24 are directly-entered fields, menu fields, check blocks or a combination thereof.

In some embodiments, the processing module 230 receives, according to the audiovisual table T1, an audiovisual selection signal indicative of selecting a selected audiovisual data (D3, for example) from the audiovisual data D1-D6 and provides, according to the audiovisual selection signal, a preview frame VF for the selected audiovisual data D3, as shown in FIG. 9. Therefore, the processing module 230 displays the contents of the selected audiovisual data D3 in a preview window in the user interface 250 to allow the user to confirm the contents of the selected audiovisual data D3. In some embodiments, the user makes a confirmation-oriented single click or selects a specific option in a right-click menu to enable the mobile device 20 to be informed of the selected audiovisual data D3 selected by the user and display on the user interface 250 a preview window for presenting or playing the contents of the selected audiovisual data D3.

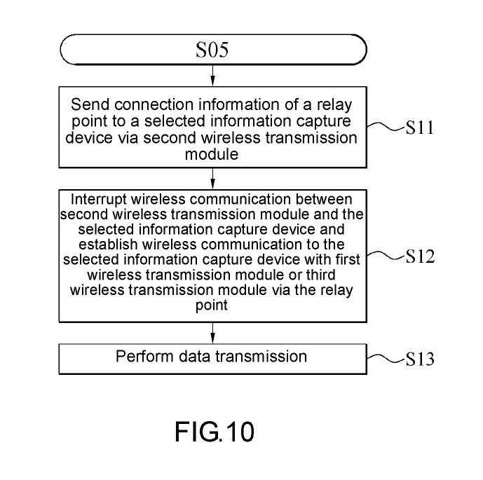

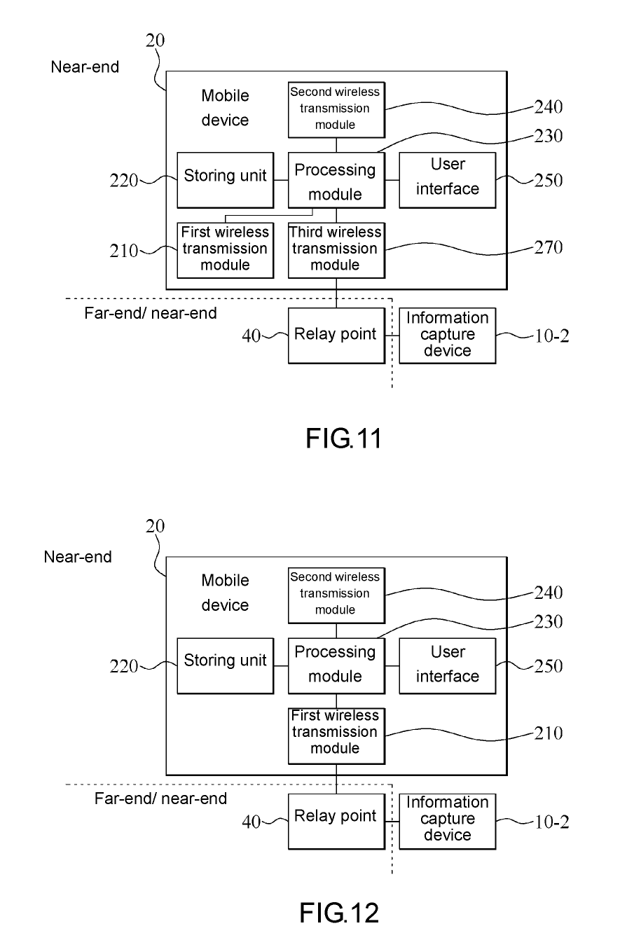

FIG. 10 is a schematic view of the process flow of the connecting method to an information capture device according to another embodiment of the present invention. FIG. 11 is a block diagram of the mobile device of FIG. 1 according to another embodiment of the present invention. Referring to FIG. 10 and FIG. 11, in this embodiment, after the mobile device 20 receives the identification data from the server 30, the first wireless transmission module 210 of the mobile device 20 interrupts its wireless communication with the server 30. Then, upon establishment of wireless communication between the second wireless transmission module 240 of the mobile device 20 and the selected information capture device 10-2 (step S05), the processing module 230 reads connection information of a relay point 40 from the storing unit 220 and sends the connection information of the relay point 40 to the selected information capture device 10-2 via the second wireless transmission module 240 (step S11). After the connection information is successfully sent (for example, upon receipt of a confirmation signal from the selected information capture device 10-2,) the processing module 230 interrupts the wireless communication between the second wireless transmission module 240 and the selected information capture device 10-2 and establishes a wireless communication to the selected information capture device 10-2 with the first wireless transmission module 210 via the relay point 40 (step S12). After the wireless communication is established (step S12), the processing module 230 performs data transmission with the selected information capture device 10-2 via the first wireless transmission module 210 and the relay point 40 (step S13). The relay point 40 assists in establishing the wireless communication between the mobile device 20 and the selected information capture device 10-2. Upon establishment of the wireless communication, the relay point 40 forwards data transmitted between the mobile device 20 and the selected information capture device 10-2.

FIG. 12 is a block diagram of the mobile device of FIG. 1 according to yet another embodiment of the present invention. Referring to FIG. 12, in some embodiments, the mobile device 20 further comprises a third wireless transmission module 270, and the third wireless transmission module 270 is coupled to the processing module 230.

Referring to FIG. 10 and FIG. 12, in this embodiment, after the connection information pertaining to the relay point 40 is successfully sent (for example, upon receipt of a confirmation signal from the selected information capture device 10-2), the processing module 230 interrupts the wireless communication between the second wireless transmission module 240 and the selected information capture device 10-2 and establishes a wireless communication to the selected information capture device 10-2 with the third wireless transmission module 270 via the relay point 40 (step S12). After the wireless communication is established (step S12), the processing module 230 performs data transmission with the selected information capture device 10-2 via the third wireless transmission module 270 and the relay point 40 (step S13).

In some embodiments, the relay point 40 is a far-end device or near-end device. The relay point 40 is a connection server or wireless access point (AP).

In some embodiments, connection information of the relay point 40 is a service identifier of the relay point 40 or a security-oriented user password in use. The service identifier is, for example, SSID (service set identifier). The security-oriented user password in use is, for example, WEP (Wireless Encryption Protocol) or WPA (Wi-Fi Protected Access).

In some embodiments, the processing module 230 is an SoC (System on a Chip), CPU (central processing unit), or MCU (microcontroller unit), but the present invention is not limited thereto.

In some embodiments, the storing unit 220 is provided in the form of one or more storing components. The storing components are each a nonvolatile memory (for example, read-only memory (ROM) or flash memory), or a volatile memory (for example, random-access memory (RAM)).

In some embodiments, the first wireless transmission module 210 is a mobile communication module or WiFi-enabled transmission module. In some embodiments, the third wireless transmission module 270 is a mobile communication module or WiFi-enabled transmission module but differs from the first wireless transmission module 210 in terms of an applicable communication protocol. The mobile communication module operates, for example, in a 3G, 4G or 5G environment.

In some embodiments, the second wireless transmission module 240 is a Bluetooth-enabled transmission module or WiFi-enabled transmission module. The second wireless transmission module 240 differs from the first wireless transmission module 210 in terms of an applicable communication protocol. The Bluetooth communication protocol is, for example, Classic Bluetooth, Bluetooth High Speed, or Bluetooth Low Energy (BLE).

In conclusion, a connecting method to an information capture device according to embodiments of the present invention is applicable to a mobile device so that the mobile device establishes a wireless communication to the information capture device anytime for the sake of data transmission, rendering feasible to confirm, save, and/or edit data captured by the information capture device anytime.

Although the present invention is disclosed above by preferred embodiments, the preferred embodiments are not restrictive of the present invention. Changes and modifications made by persons skilled in the art to the preferred embodiments without departing from the spirit of the present invention must be deemed falling within the scope of the present invention. Accordingly, the legal protection for the present invention should be defined by the appended claims.

What is claimed is:

1. A connecting method to an information capture device, comprising the steps of:
establishing a wireless communication to a server with a first wireless transmission module;
executing a certification procedure with the server via the first wireless transmission module after the wireless communication is established;
receiving an identification data from the server after the certification procedure is passed;
receiving connection information of at least one portable information capture device via a second wireless transmission module according to the identification data; and
establishing a wireless communication to a selected information capture device of the at least one portable information capture device with the second wireless transmission module according to the connection information of the selected information capture device, thereby transmitting data between the selected information capture device and the second wireless transmission module.

2. The connecting method to an information capture device according to claim 1, wherein the data transmitting step involves receiving by the second wireless transmission module at least one audiovisual data from the selected information capture device.

3. The connecting method to an information capture device according to claim 2, further comprising:
displaying an audiovisual table of the at least one audiovisual data after the at least one audiovisual data is received.

4. The connecting method to an information capture device according to claim 3, further comprising:
receiving, according to the audiovisual table, an audiovisual selection signal indicative of selecting a selected audiovisual data from the at least one audiovisual data; and
providing an edit field for at least one audiovisual information item of the selected audiovisual data according to the audiovisual selection signal.

5. The connecting method to an information capture device according to claim 3, further comprising:
receiving, according to the audiovisual table, an audiovisual selection signal indicative of selecting a selected audiovisual data from the at least one audiovisual data; and
providing a preview frame for the selected audiovisual data according to the audiovisual selection signal.

6. The connecting method to an information capture device according to claim 1, further comprising:
sending connection information of a relay point to the selected information capture device with the second wireless transmission module; and
interrupting the wireless communication between the second wireless transmission module and the selected information capture device and establishing a wireless communication to the selected information capture device with a third wireless transmission module via the relay point after sending the connection information of the relay point.

7. The connecting method to an information capture device according to claim 1, further comprising:
sending connection information of a relay point to the selected information capture device with the second wireless transmission module; and
interrupting the wireless communication between the second wireless transmission module and the selected information capture device and establishing a wireless communication to the selected information capture device with the first wireless transmission module via the relay point after sending the connection information of the relay point.
